(19) United States
(12) Patent Application Publication
(10) Pub. No.: US 2002/0156711 A1
(43) Pub. Date: Oct. 24, 2002

(54) Method for effecting chattel paper transactions

(76) Inventor: Ronald DeKoven, New York, NY (US)

Correspondence Address: HALE AND DORR LLP, 300 PARK AVENUE, NEW YORK, NY, 10022, US

(21) Appl. No.: 09/912,203

(22) Filed: Jul. 24, 2001

(51) Int. Cl. G06F 17/60

(52) U.S. Cl. 705/36

(57) ABSTRACT

A method processes a portfolio of chattel paper, typically including retail installment sales contracts, transferred from an originator to its SPE and then to a first trust, the trust creating a Certificate of Beneficial Interest (CBI) for the transferred portfolio. The CBI is issued from the first trust to a second trust. The second trust issues a non-recourse, investment grade note, secured by the CBI, to the first trust in exchange for the CBI. The note is transferred from the first trust to the SPE of the originator in exchange for the entire portfolio. The note is then marketed directly, indirectly, through the Internet, or otherwise, from the SPE of the originator to a purchaser; the proceeds are then transferred by the SPE to the originator. Fewer trusts can be employed and a “true sale” can be used to further meet the goals of the invention.

The invention relates generally to the processing of portfolios of chattel paper and, in particular, to a method for enabling an owner of chattel paper to sell the entire portfolio at market for cash while removing chattel paper from the owner's financial statements, freeing capital for new business.

As businesses loan money, they take in return loans or leases (sometimes referred to as chattel paper) and will typically aggregate the loans or leases into portfolios. When the chattel paper remains on the books of the financing company, certain reserves and limitations are imposed by regulators, rating agencies and others; this could ultimately restrict the financing company from making further loans or leases. As a result, companies such as banks, credit organizations, and credit arms of large retailers, such as, for example, Ford, IBM, or Mitsubishi, typically look for various ways to remove portfolios of their loans or leases from their financial statements. The amount they receive for those portfolios is heavily dependent upon the quality of the portfolio.

Sales of chattel paper portfolios today are infrequent. There exist no documentation standards, diligence is lengthy and expensive, and so the market is limited. Additionally, financing companies incur costs to originate portfolios that are unlikely to be recouped by the sale of a raw portfolio without some level of credit enhancement or modification. The sale can be either direct, at auction, or using some other mechanism whereby a willing purchaser takes over full financial risk responsibility for the chattel paper portfolio and receives the installment payments, sometimes provided through the originating loan entity, which acts as both a seller and a servicing agent for the purchaser. Today, these transactions are usually limited to one-time sales when a loan originator is exiting a given business segment. No liquid market exists today for sales of chattel paper portfolios.

As a result, various securitization methodologies have been created to monitize the leases and loans. These methodologies however are still awkward to deal with, require substantial time to complete, and still do not effectively remove 100% of the chattel paper portfolio from the originator's books. A portion of the portfolio remains with the seller as a “first loss” or equity piece, which has regulatory, financial accounting or rating agency implications for the originator.

The claimed invention advantageously provides a new methodology for removing 100% of the chattel paper portfolio from the originator's books. This methodology advantageously allows the originator to better use its financial assets and can also increase its return on its chattel paper portfolio. Further, the method of the invention provides an easy implementation and the ability to use modern technologies, including the Internet.

### SUMMARY OF THE INVENTION

The invention relates to a method for processing a portfolio of chattel paper and an electronic system that efficiently executes the workflow and trading of chattel paper portfolios through a paperless, user initiated environment. This method for processing features transferring the chattel paper portfolio from an originator to a trust, ultimately issuing a non-recourse, investment grade note from a trust to the originator effectively in exchange for the entire portfolio of chattel paper, and marketing or selling the note to a purchaser.

In another particular embodiment, the invention relates to a method for processing a portfolio of chattel paper and features transferring the chattel paper portfolio from an originator to a first trust, transferring a Certificate of Beneficial Interest (CBI) for said portfolio of chattel paper from the first trust to a second trust, issuing a non-recourse investment grade note from the second trust to the first trust in exchange for the CBI, transferring said note to the originator in exchange for the portfolio, and selling or marketing the note to a purchaser.

In yet another aspect of the invention, the invention relates to a method for processing a portfolio of chattel paper and features transferring the chattel paper portfolio from an originator to a first trust, creating at the first trust a CBI for the transferred chattel paper portfolio, issuing the CBI from the first trust to a second trust, issuing a non-recourse, investment grade note from the second trust, secured by the CBI, to the first trust in exchange for the CBI, transferring the note from the first trust to the originator in exchange for the entire portfolio of chattel paper, and marketing or selling the transferred note from the originator to a purchaser.

In yet another aspect of the invention, a system for selling chattel paper has a sale server creating investment grade, non-recourse notes, each note secured by a Certificate of Beneficial Interest (CBI) based on a portfolio of rateable and unrateable chattel paper, buyer sites at which a purchaser accesses the sale server for purchasing the notes in an auction process, an interconnection communications system interconnecting the buyer sites and the sale server for communications therebetween, and, at the sale site, computer software for implementing instructions for (i) creating an auction of the notes whereby buyer sites can bid against one another to purchase the notes, (ii) enabling buyer sites to review the defining parameters of each note, and (iii) enabling buyer sites to access tools for evaluating each note.

### BRIEF DESCRIPTION OF THE DRAWINGS

Other objects, features, and advantages of the claimed invention will be apparent from the following drawings, taken together with the following description, in which:

FIG. 1 is a flow chart illustrating a first preferred embodiment in accordance with the invention;

FIG. 2 is a more detailed illustration of the note of the invention;

FIG. 3A-3O are screen shots illustrating operation of an embodiment of the invention; and

FIG. 4 is a view of various electronic elements of the invention.

### DESCRIPTION OF A PARTICULAR PREFERRED EMBODIMENT

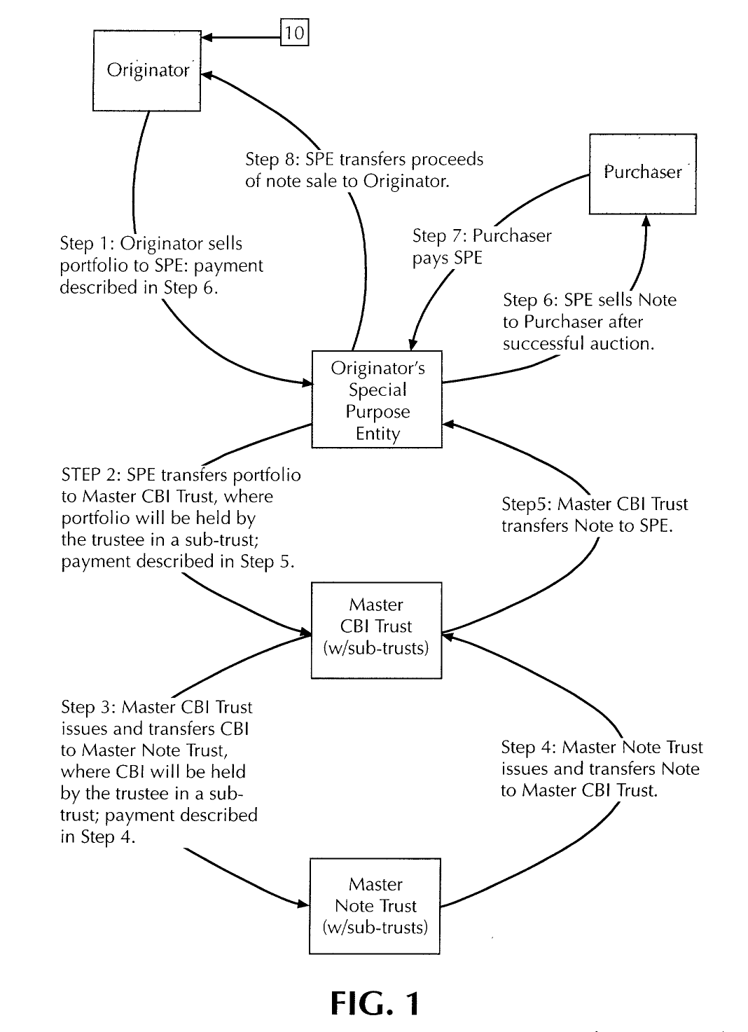

Referring now to FIG. 1, in accordance with a first embodiment of the invention, an originator 10 or owner of a portfolio of chattel paper, for example retail installment sales contracts, creates a so-called “true sale” to an originator-owned Special Purpose Entity (SPE) 12. The originator-owned SPE then transfers or otherwise sells the chattel paper to a master CBI trust 14. The master CBI trust creates a Certificate Of Beneficial Interest (CBI) for the chattel paper and then issues that CBI to a second trust, the master note trust 16. The CBI and the note described below are paperless “documents”. The two trusts, the CBI trust and the note trust, both have subtrusts therewithin for each of the portfolios (or CBIs) which they are requested to handle. The master note trust 16 then issues a note which is sold to the master CBI trust in exchange for the CBI which is issued to it. There can be more than one note created and, in fact, in some embodiments of the invention, the CBI itself can have note-like qualities so that a separate note and indeed a separate note trust 16 need not be created. The availability of the two trusts 14 and 16, however, provide added flexibility to the methodology in accordance with the invention which in some instances can be advantageous.

For the embodiment illustrated in FIG. 1, then, the master CBI trust then transfers the note received from the master note trust to the originator-owned SPE in exchange for the portfolio of chattel paper. It is important to recognize that the note issued by the master note trust 16 is a non-recourse note secured by the assets or properties in the chattel paper portfolio. The note can be and is then marketed through one of many different marketing approaches. In accordance with the preferred embodiment, an Internet auction is held. In other embodiments, the note may be sold in a private market transaction, may be offered to a select group of purchasers, etc. Thereafter, once a purchaser is identified either by auction or otherwise, the SPE sells the note to the purchaser and receives the financial benefit from the purchaser in exchange therefor. The SPE, in this preferred embodiment, then transfers such benefit to the originator 10 in payment for the chattel paper. In this manner, the originator removes from his financial statements all of the chattel paper in the portfolio, with nothing being retained.

If the purchaser desires a CBI instead of a note, then the associated subtrust of the master note trust can terminate the subtrust relating to the note, and in place, the master CBI subtrust can issue to the originator SPE, the CBI in lieu thereof. This method step can only be effected by holders of 100% of the affected master note trust subtrust.

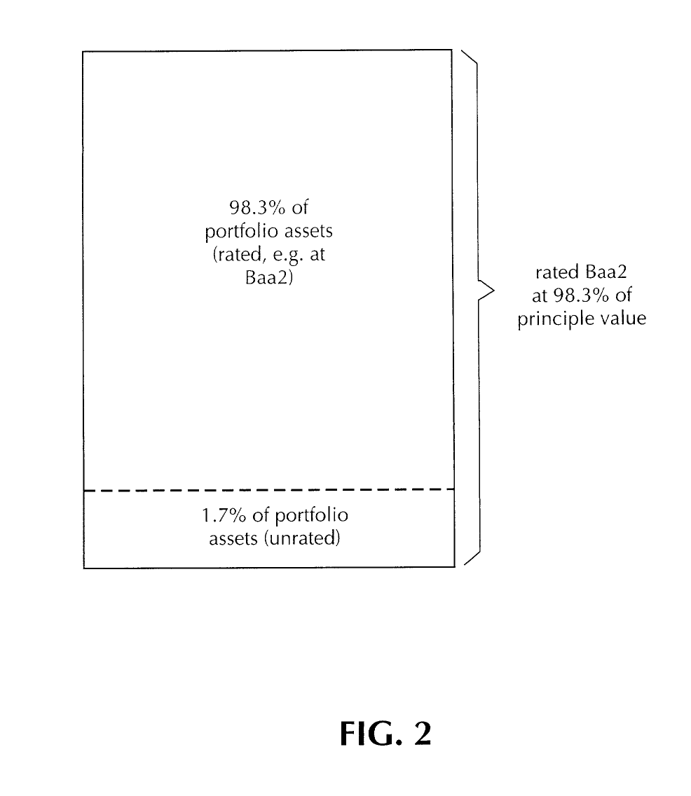

In a typical securitization, referring to FIG. 2, there will be a large percentage, for example 98.3%, of Grade Baa2 (or better), securities, which correspond to the lowest investment grade rating given by, for example, Moody's. The remaining securities collateralized by the chattel paper portfolio, here 1.7% of the portfolio, would be unrated and generally retained by the originator. However, it is just as important to the originator to remove these unrated assets from its financial statements as it is to remove the rated assets. Accordingly, in accordance with the invention, the entire portfolio of chattel paper is treated as an asset and, using the percentages above as an example, the asset is collateralized by a note created, in the example illustrated by FIG. 1, at the second trust. The note is a non-recourse note, having a principal amount equal to 98.3 (in this example), which represents the percentage of the chattel paper that would have been rated in a securitization, having a term of years, for example 4 years, and a set interest rate, determined generally by the investment grade and tenor of the note. The note may or may not have a contingent balloon payment as well, the balloon payment being in the form of principal and interest, and in essence representing the risk of the unrated portion of the asset (1.7% of the asset in this example) in said securitization being paid in accordance with its terms, both in principal and interest. The note, with these qualities and parameters, will then be rated, typically at at least a Baa2 rating, the lowest investment grade currently set by Moody's. It is this note, which is secured by the CBI, which the master note subtrust issues to the master chattel paper subtrust in the embodiment of FIG. 1.

In this manner, the originator is able to transform the entire portfolio of chattel paper into a security bearing an investment grade rating, which he can then sell or market in any manner acceptable to the originator. All of the assets making up the portfolio of chattel paper are then removed from his financial statements with the advantageous consequences noted above.

In another aspect of the invention, the note, now carrying an investment grade rating, is sold as noted above in one of several channels. In one aspect, the note can be auctioned in an Internet auction and, depending on market conditions, will command a current market value which may be, depending upon the terms of the note, above its principal value. The note is non-recourse and, accordingly, is secured by the Certificate of Beneficial Interest (CBI) provided by the subtrust of trust 14. At the maturity date of the note, as noted above, a balloon payment could be due, depending upon the payment history, of the portfolio represented by the CBI.

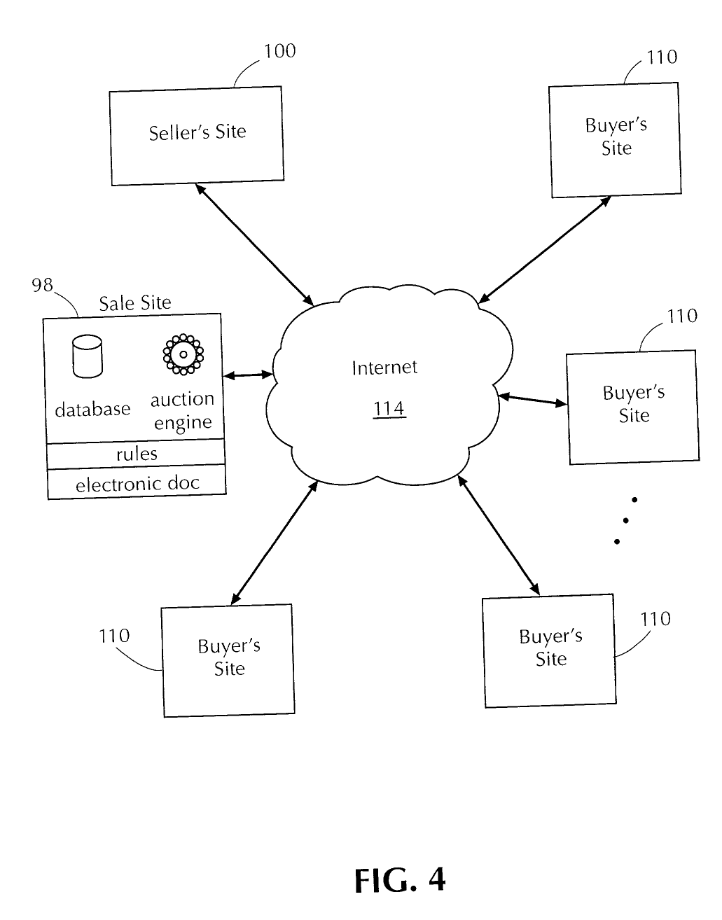

Referring to FIG. 4, in a typical transaction, an auction can be conducted over the Internet from an SPE of an originator of a portfolio of chattel paper (hereafter referred to as “seller”) at site 100 who provides one or more auction items (notes), including the non-recourse note identified above, which is issued by a trust and secured by a CBI. The seller provides these “auction items” over the Internet in a secured manner through a sale site 98 whereby potential investors/purchasers can bid on each of the available notes under prescribed terms which include, for example, the term of the note, the coupon rate, Moody's or Fair Isaac's rating, and face value. In addition, the term may include, as stated above, a balloon payment (albeit not guaranteed), etc. Each potential purchaser (hereafter known as “buyer”) site 110 thus has the capability of participating in the auction. The note will be going to the highest acceptable bidder subject to the terms of the auction, such as a reserve, etc. The auction is performed with each buyer or purchaser having access, over the Internet 114, to a common sale site 98 (should there be more than one originator participating in the auction), and to details of each of the potential assets available for purchase at the site. The sale site includes an auction engine (processor), 112, a database 114, the rules of the auction 116, and electronic documents representing, for example, the note, time, etc. Terms of financial transfer, etc., are set up in accordance with standard practices.

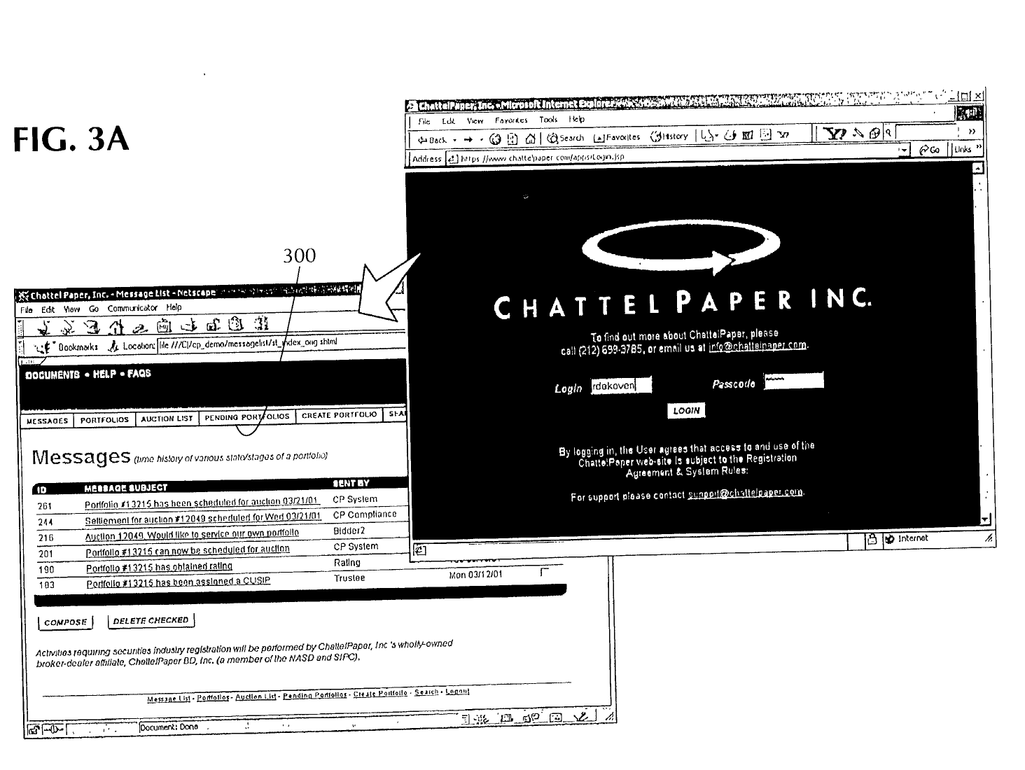

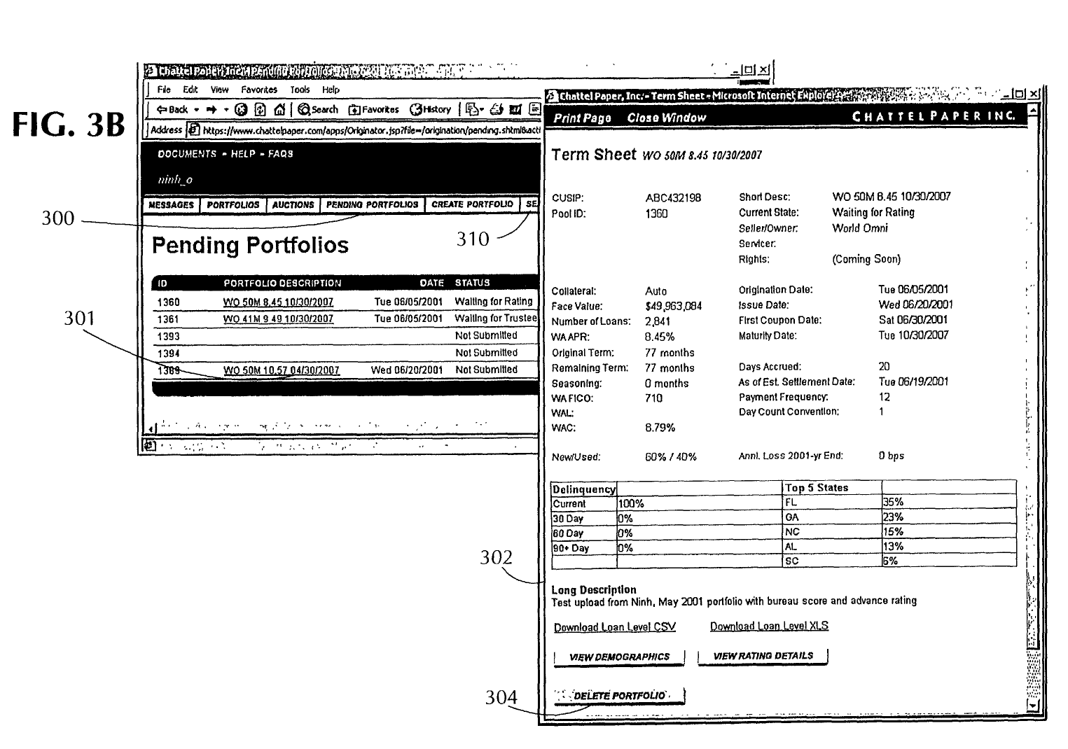

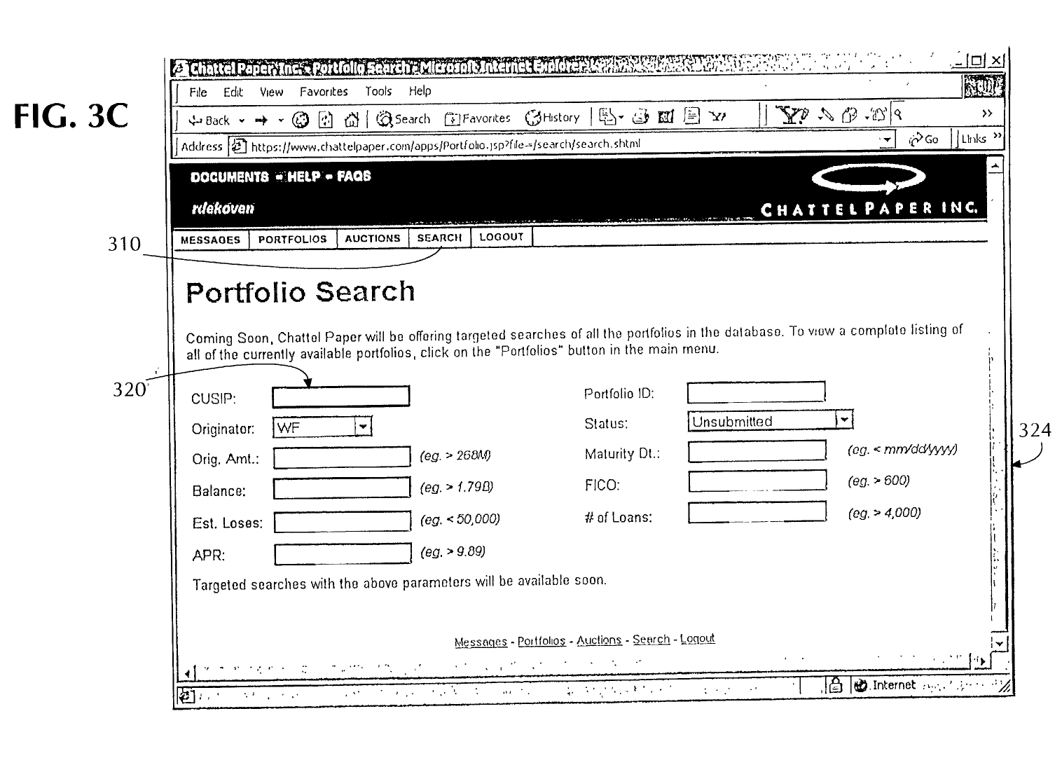

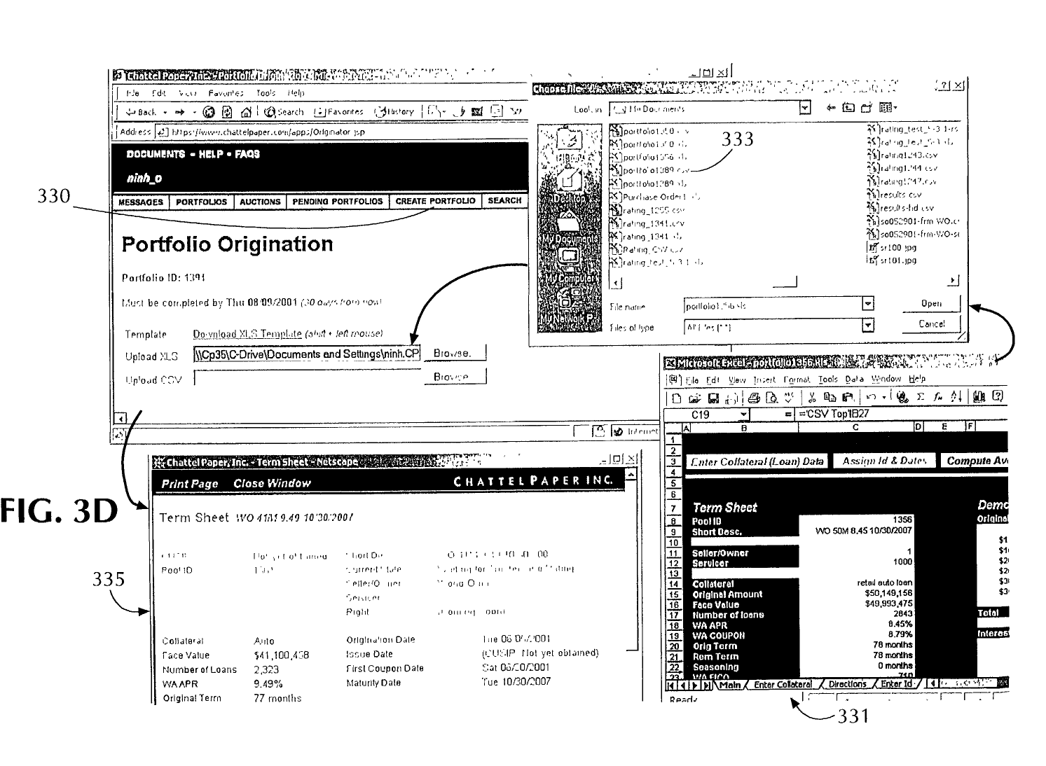

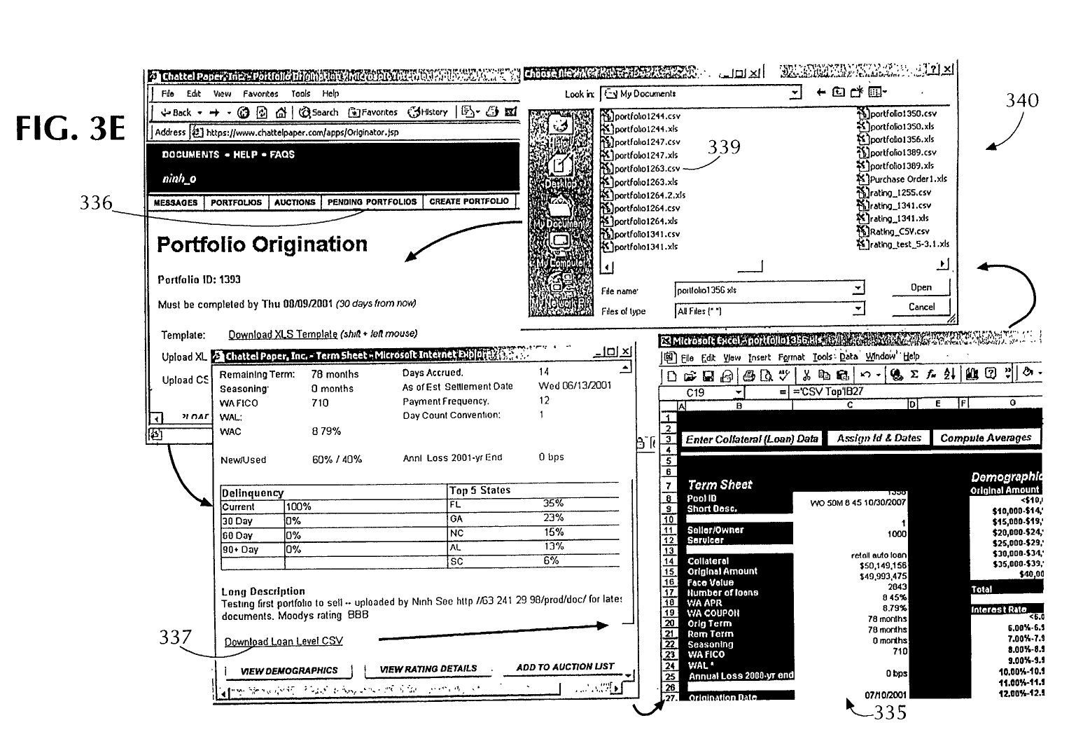

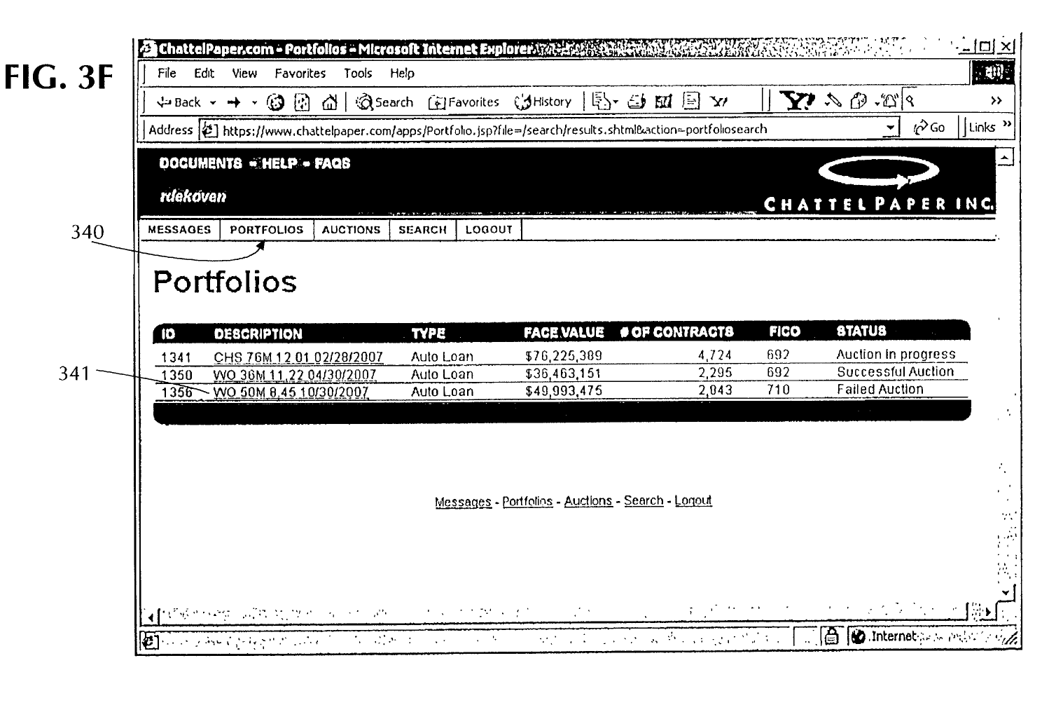

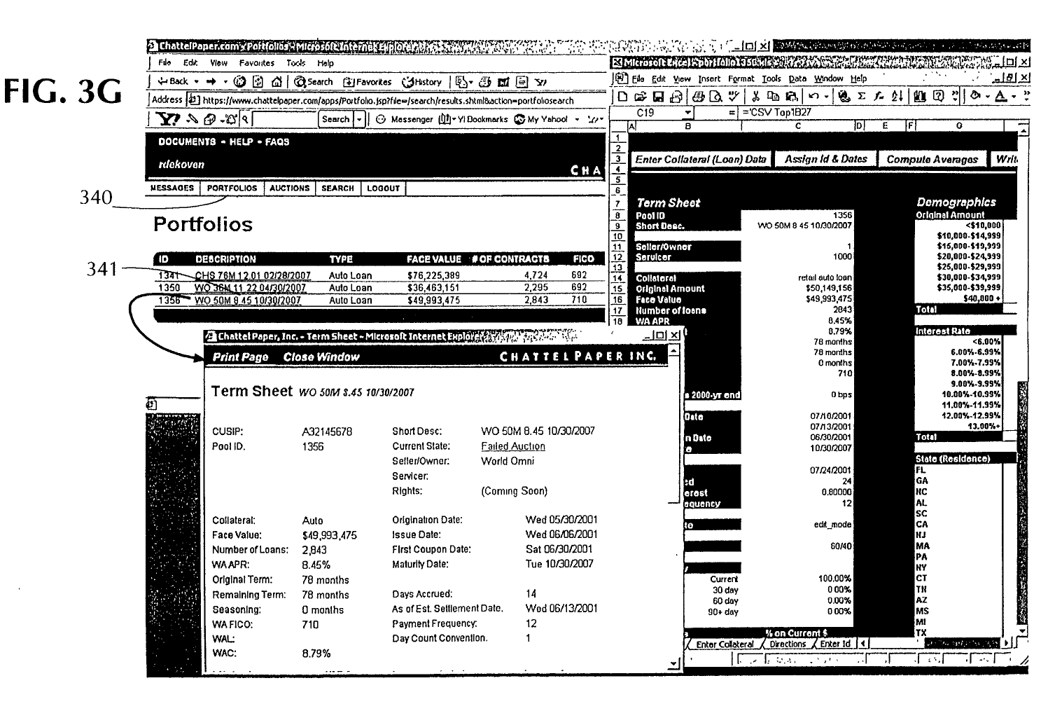

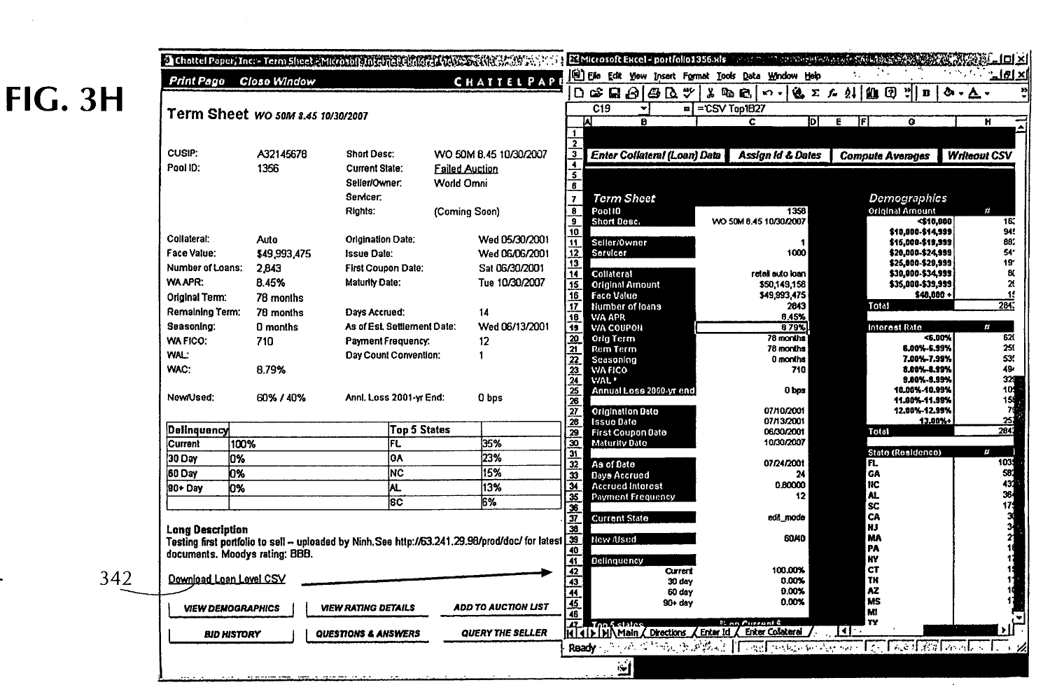

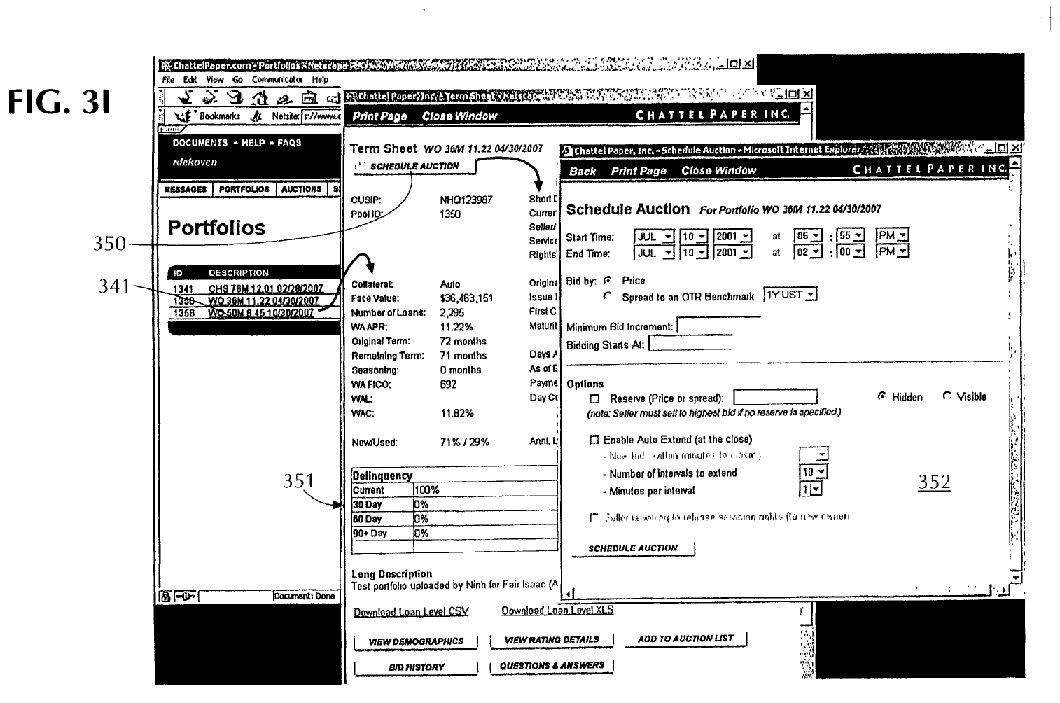

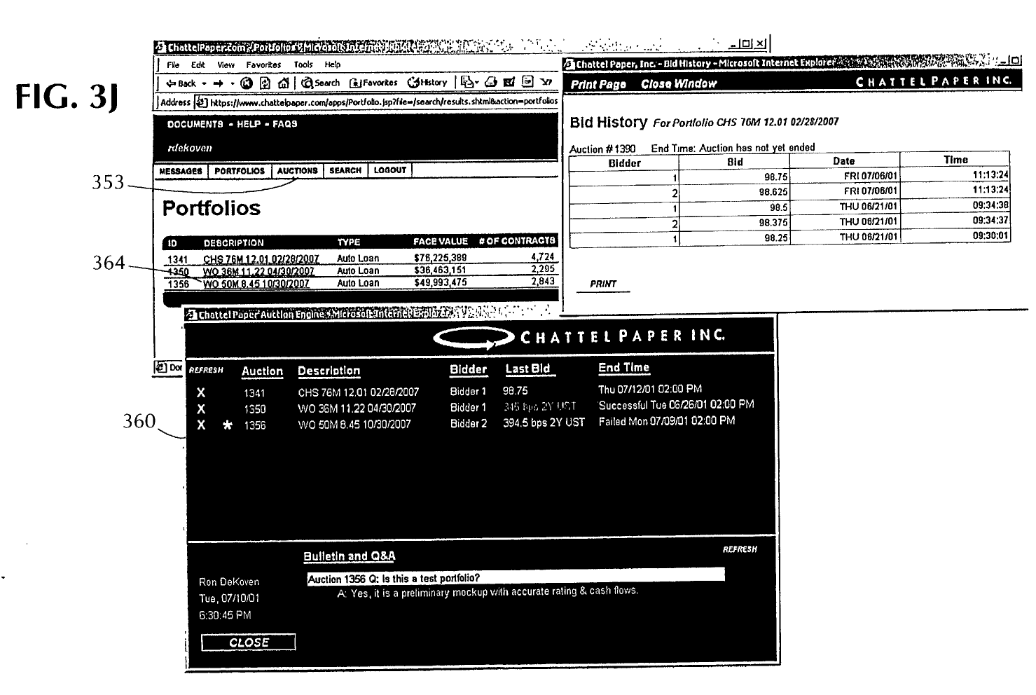

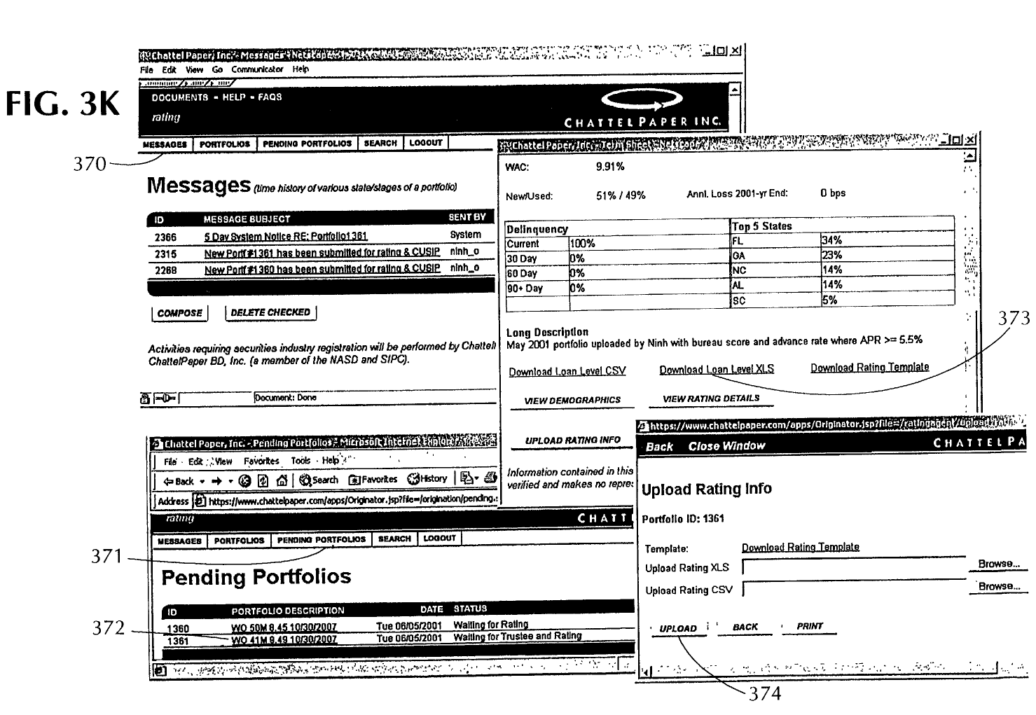

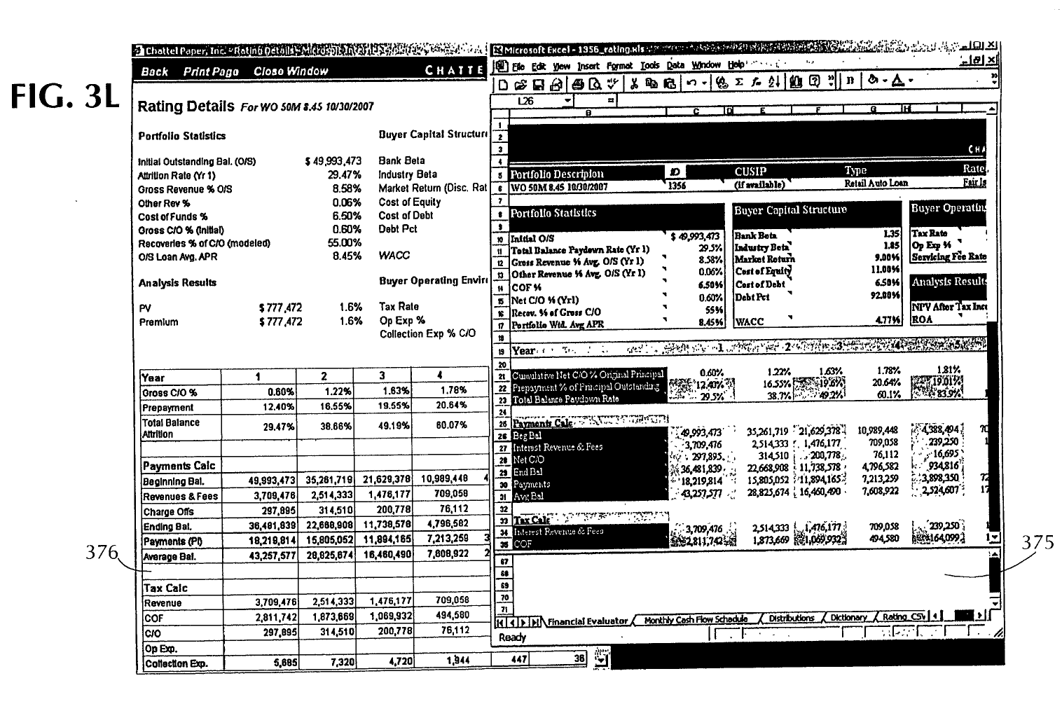

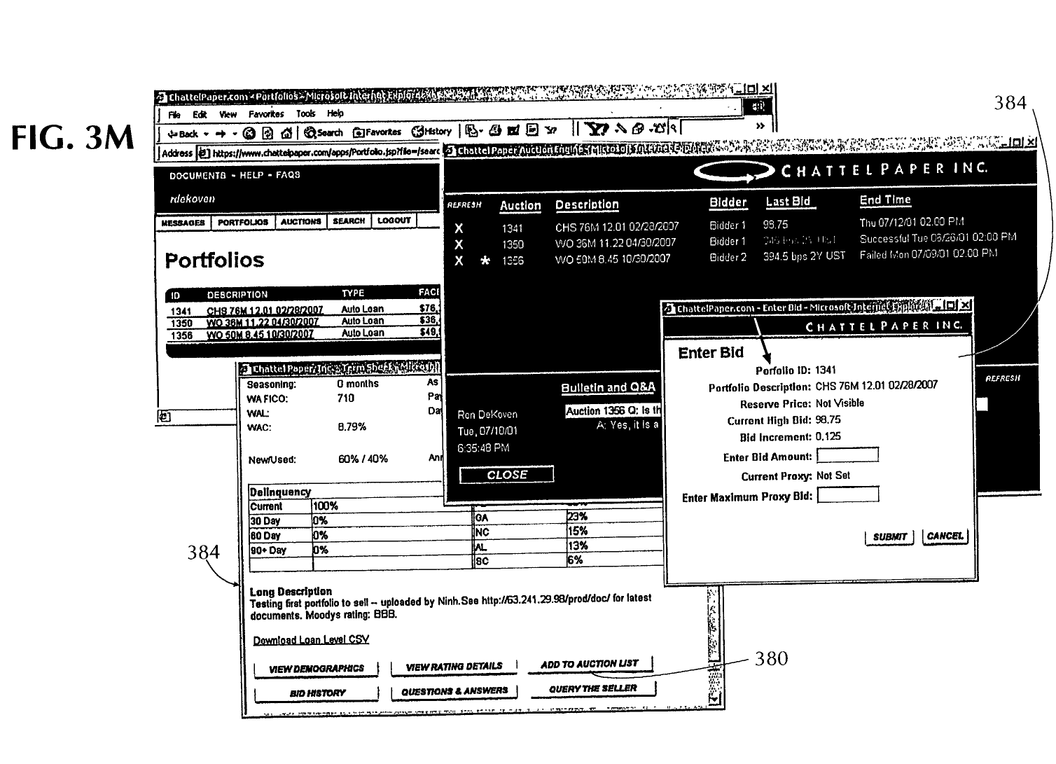

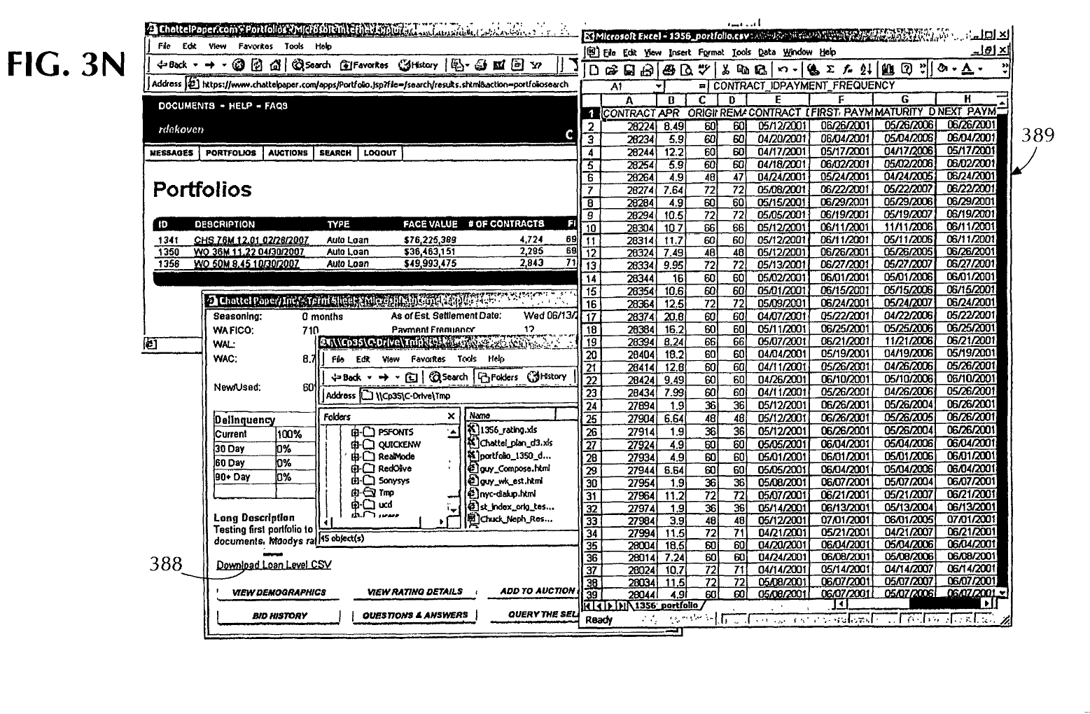

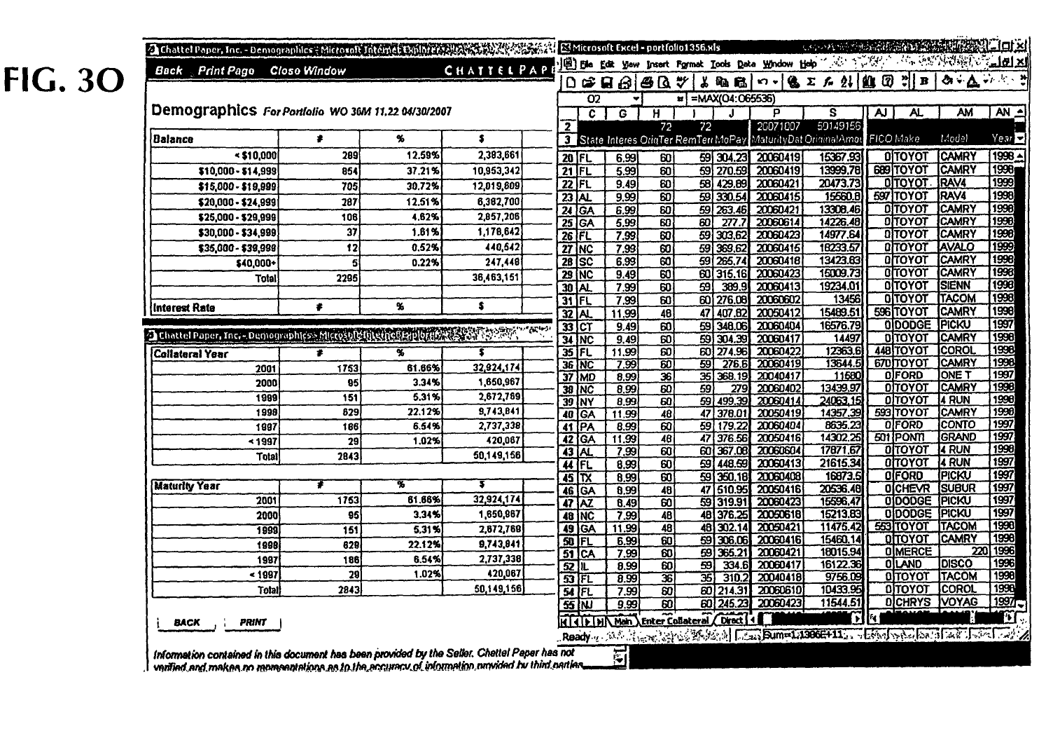

In operation, referring to FIGS. 3A-30, in accordance with one embodiment of the invention, an auction environment is created over the Internet. The user (seller in FIG. 3A) logs into the system (at site 98) by providing a login and a security ID. In a preferred embodiment of the invention, the security ID employs concepts such as SecureID which creates a high level of security. Note also, as shown in FIG. 3A, that the user logs into a pre-registered account. Upon entering into the system, a seller receives messages, collected since its last login, indicating various activities to which the seller needs to review and/or attend. At this point, the seller, referring to FIG. 3B, can select to view all portfolios (button 300) and for any particular portfolio, can select at 301 that portfolio and examine it in more detail (indicated at 302), and can delete elements (button 304), etc. as illustrated by the buttons at the bottom of the screen. Further, the seller can search (310) the portfolios, given defining parameters 320 entered into a portfolio search screen 324 illustrated in FIG. 3C. Next, or alternatively, the user can create a new portfolio (330), see FIG. 3D. In a preferred embodiment, a new chattel paper portfolio can be originated by the seller using standardized Excel stratification reports 331, downloadable from the site. The system will provide a functional flow which takes business data, within a binary Excel, saving to an intermediate CSV (comma separated value (a generic data file)) file (for example, a file 333), and to upload all seller chattel paper portfolio data to the internet based sale site 98, without the overhead and need of an in house technology staff. This provides an efficient and standard approach where all sellers can originate new chattel paper portfolios online. Once uploaded, data can be re-downloaded (at 337) (FIG. 3E) by many other parties from the sale site to each user's local workstation (100, 110) as, for example, a term sheet 335 for storage at 339. The new portfolio is not assigned an ID number until it is first saved, and a CUSIP will later be assigned to the note by the trustee. An individual contract can be deleted (button 304, FIG. 3B) prior to submission for auction.

For any existing portfolio, the details can be illustrated and retrieved (340) either by ID number, by CUSIP number or by hyper text link description (341), as illustrated in FIGS. 3F, 3G. Details can conveniently be obtained (342) as illustrated in more detail in FIG. 3H. The seller can also, as shown in FIG. 3I, schedule an auction by clicking on the schedule button (350) in screen 351 (opened at 341), and indicate, at screen 352, at his discretion: start time and date; minimum bid increments; reserve price; whether the auction should be extended for a time period, typically a few minutes, if the bidding is close and a better price may be achieved by extending the auction. Referring to FIG. 3J , when the system is in the auction mode (353), that is, while an auction is taking place, the seller can view all of the bids (360) and/or the portfolio details (364). In accordance with the system, the pending button (300) displays only the next action to be applied to each portfolio, see FIG. 3B. The history of a portfolio development is illustrated in FIG. 3A by viewing the queued messages.

Before a portfolio is auctioned by the seller, the system will be rated by a designated agency (to provide a credit, risk, defaults and cash flow analysis). This rating data will be uploaded by the same agent using comparable manners explained earlier for the seller, see FIG. 3K. Notification will be sent to inform all parties involved as shown by example messages in FIG. 3B. A rating agent will login, review his “to do” messages (370), access his pending list (371), select a portfolio (372) and download perspective data about a note (373), perform his rating off line, and at a later time, upload (374) the rated note to provide rated results back online for all users, see FIG. 3K. The system provides standardized electronic work flow process to automate the business data in Excel (375) to a web based format (376), see FIG. 3L. Once rated, the note can be scheduled for auction.

In a comparable manner, a buyer site 110 is typically welcomed to the system after login by presentation of a series of messages. Like the seller, the buyer can view all of the portfolios and can add one or more of the portfolios, which have been scheduled or which are in auction, to his auction bid list or watch list by actuating button 380, as illustrated in FIG. 3M. Like the seller, the buyer can view all public auctions, and can start a bid process (384) for the portfolio should it desire. Tools are also provided for valuation of the portfolio and examination of the collateral (389) can be obtained (388), as illustrated in FIGS. 3M, 3N. The buyer can also effect a search for portfolios having various defining parameters such as a minimum yield as illustrated (FIG. 3C). Further, as shown in FIG. 3O, further details of a given portfolio can be examined by a potential buyer; and, as illustrated in previous FIG. 3J, the buyer has the ability to obtain a full bid history of the auction.

The system also enables a buyer or seller to set preferences, and do an evaluation of its own performance by identifying additional materials from the auction to analyze. In addition, the system provides other analysis tools, as needed, which enable the buyer, and the seller, both before, during, and after an auction, to evaluate their performance, to understand better what occurred during the auction in order to determine whether or not alternate actions should be taken in future auctions. For example, a seller can try to determine why some auction portfolios sold well and others did not.

In various aspects of the invention, different elements, meeting the goal of the invention, may be employed. For example, while the trusts 14 and 16 identified in the preferred embodiment described above are considered more flexible, it is also possible to use one trust, and, by using one trust, as noted above, the CBI could have note-like attributes so that an actual note need not be created. Further, while the preferred embodiment employs a “true sale” to the originator's SPE 12, that element need not be employed if, in the opinion of the originator and its advisors, the “true sale” is not needed.

Additions, subtractions, and other modifications of the preferred embodiment of the invention will be apparent to those practiced in this field and are within the scope of the following claims.

What is claimed is:

1. A method for processing a portfolio of chattel paper comprising:
(i). transferring said chattel paper portfolio from an originator to a trust;
(ii). issuing a note from the trust to one of the originator or its SPE in exchange for the portfolio of chattel paper; and
(iii). selling said note to a purchaser.

2. A system for selling chattel paper comprising:
(i). a sale server creating investment grade non-recourse notes, each note secured by a Certificate of Beneficial Investment (CBI) based on a portfolio of rateable and unrateable chattel paper;
(ii). buyer sites at which a purchaser accesses said sale server for purchasing said notes in an auction process;
(iii). an interconnection communications system interconnecting said buyer sites and said sale server for communications therebetween; and
(iv). at the originator site, computer software for implementing instructions for:
creating an auction of said notes whereby buyer sites can bid against one another to purchase said notes;
enabling buyer sites to review the defining parameters of each note, and
enabling buyer sites to access tools for evaluating each note.

3. A secured investment grade note secured by chattel paper comprising:
(i). a non-recourse element;
(ii). an investment grade rating;
(iii). a face value no greater than the rated assets value;
(iv). a rating rendering the note of investment grade value; and
(v). said note being secured based upon said chattel paper.

4. The secured investment grade note of claim 3 further comprising:
(i). said note being secured by a Certificate of Beneficial Interest issued on said assets.

5. A method for processing a portfolio of chattel paper comprising:
(i). transferring said chattel paper portfolio from an originator to a first trust;
(ii). transferring a Certificate of Beneficial Interest representing said portfolio of chattel paper from said first trust to a second trust;
(iii). issuing a note from the second trust to the first trust in exchange for said Certificate of Beneficial Interest;
(iv). transferring said note to one of the originator or its SPE in exchange for the portfolio; and
(v). selling said note to a purchaser.

6. A method for processing a portfolio of chattel paper comprising:
(i). transferring said portfolio from an originator to a first trust;
(ii). creating a Certificate of Beneficial Interest (CBI) for said transferred portfolio;
(iii). issuing said CBI from said first trust to a second trust;
(iv). issuing a note from the second trust to the first trust in exchange for the CBI;
(v). transferring said note from the first trust to one of the originator or its SPE in exchange for the portfolio; and
(vi). selling said transferred note to a purchaser.

7. The method of claim 6, wherein said first transferring step comprises:
(i). selling said portfolio to an originator-owned special purpose entity (SPE) in a “true sale”; and
(ii). transferring said portfolio from the originator's SPE to said first trust.

8. The method of claim 7 wherein said selling step further comprises:
marketing said note for sale to said purchaser.

9. The method of claim 8 wherein said marketing step comprises:
auctioning said note to said purchaser.

10. The method of claim 6 wherein said note is a non-recourse note.

11. A method for processing a portfolio of chattel paper comprising:
(i). transferring said chattel paper portfolio from an originator to a first trust;
(ii). transferring said portfolio of chattel paper from said first trust to a second trust;
(iii). issuing a note-like Certificate of Beneficial Interest (CBI) from the second trust to the first trust in exchange for the portfolio;
(iv). transferring said CBI to one of the originator or its SPE in exchange for the portfolio; and
(v). selling said CBI to a purchaser.
